(19) United States
(12) Patent Application Publication
(10) Pub. No.: US 2023/0014572 A1
(43) Pub. Date: Jan. 19, 2023

(54) SYSTEM AND METHOD FOR EMPLOYEE RETENTION

(71) Applicant: Toshiba TEC Kabushiki Kaisha, Shinagawa-ku (JP)

(72) Inventor: Christopher Nguyen, Lake Forest, CA (US)

(21) Appl. No.: 17/376,579

(22) Filed: Jul. 15, 2021

(51) Int. Cl. G06Q 10/10; G06N 20/00; G06K 7/10

(52) U.S. Cl. CPC G06Q 10/105; G06N 20/00; G06K 7/10366; G06K 7/10297

(57) ABSTRACT

A system and method for employee retention includes determining an employee's happiness level by analysis of their attire from a captured image. Image capture and employee identification is commenced when an employee uses their employer ID to enter a work premises. Captured images are analyzed for attire content. Attire content is categorized and analyzed relative to other fashion images to gage an employee's likes or dislikes, along with their happiness level. Remedial suggestions are generated when a happiness level falls below a set threshold level. Remedial suggestions may include gifts personal to an employee as determined from their attire. Captured images and web data are subject to artificial intelligence and machine learning to continuously improve analysis and recommendations.

### TECHNICAL FIELD

This application relates generally to human resource management. The application relates more particularly to an artificial intelligence, machine learning system that predicts happiness levels of employees by analyzing their attire relative to patterns and properties to provide recommendations to promote job retention and satisfaction.

### BACKGROUND

Employee turnover is costly. Not only can it affect company financials, but it can also impact morale of remaining employees. This may affect productivity levels of those employees. Companies may invest in numerous programs to keep their employees happy in an attempt to reduce turnovers. Typical programs are generic and applied across the company, with little or no employee personalization. Routine inspections through traditional methods, like face to face meetings with management leaders, can provide insights to the employee's happiness. However, it is done infrequently or seasonally and prone to bias. Such meetings may have an opposite effect, causing stress to employees.

### BRIEF DESCRIPTION OF THE DRAWINGS

Various embodiments will become better understood with regard to the following description, appended claims and accompanying drawings wherein:

FIG. 1 an example embodiment of a system 10 for employee retention;

FIG. 2 is an example embodiment of a system for improving employee happiness;

FIG. 3 is an example embodiment of a digital data processing device;

FIG. 4 is an example embodiment of a software block diagram; and

FIG. 5 illustrates flowchart of an example embodiment of an employee retention system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Example embodiments herein disclose an artificial intelligence (artificial intelligence) system that tracks an employee's happiness by analyzing outfits that are worn by the employee to provide a happiness score for the employee, suitably on a daily basis. Should a happiness score fall below a predetermined threshold, the artificial intelligence system notifies management leaders and provides a recommendation of corrective measures to improve the happiness score through personalized rewards. Personalized rewards are selected to boost employee happiness.

The artificial intelligence system includes an image recognition component, happiness scoring component and recommendation engine component. The image recognition component utilizes computer vision to process the images from an office building security system. The security system captures imagery of employees entering and leaving the office building, and sometimes within the office building floor space as well. Each employee's access badge allows the cataloging of the entry by date and time. Image recognition detects clothing objects worn by the employee and the system classifies the objects with the corresponding employee. Object classification is not limited to labeling of the objects but also provides metadata for the objects such as coloration, newness, size, style, branding, and fit-finish detection. The additional metadata provides information to construct an outfit ensemble. Image recognition suitably uses crowdsourcing data to further build datasets from images scraped from popular fashion websites and events that would generally have happy people using the same or similar looks. Additional external datasets are suitably used for comparing and assisting in classification and continuous learning by the machine learning models in the happiness scoring component.

The happiness scoring component is suitably comprised in a series of machine learning features. Such features are algorithms that provide pattern recognition from the image recognition component datasets and outputs a percentage scoring factor if the employee is happy, suitably on a scale, such as a scale of 1 to 100, with 100 being 100% completely happy. A score is suitably sent to an administrator to review, and possibly initiate remedial action.

The recommendation engine component is suitably triggered when a score is below a predetermined threshold level and an occurrence frequency is higher than the predetermined threshold level. The recognition engine suitably integrates with an employee recognition system to select items that correlates with the employee's fashion attire. For example, if an employee often wears golfing attire, selected items may be golf balls and tees that are personally identified as rewards for the employee.

The artificial intelligence system is suitably trained using historical dataset from the security system and Human Resources system. The Human Resources system provides historical dataset of the traditional face to face interviews, the length of time an employee stays on the job, attendance, tardiness, self-reporting surveys, and companywide surveys. The artificial intelligence system is suitably evaluated using specified targeted employees and then inspected using traditional face to face interviews to confirm happiness levels and recommendations provided.

The artificial intelligence system suitably uses supervised learning to analyze data points from employee clothing to predict the happiness level of the employees. The artificial intelligence system generates a personalized recommendation to cheer up an employee to improve and or maintain a happiness level that reduces turnover.

Crowd-sourced data, suitably obtained from freely available images of clothes shown in popular fashion websites, serves to continuously evaluate machine learning models to detecting fit and finish, newness, branding, and concepts such as “dress to impress.” Crowd-sourced data may also include data obtained from freely available images of clothes worn by people at happy events to continuously evaluate the machine learning models on detecting the outfit attire that depicts happiness

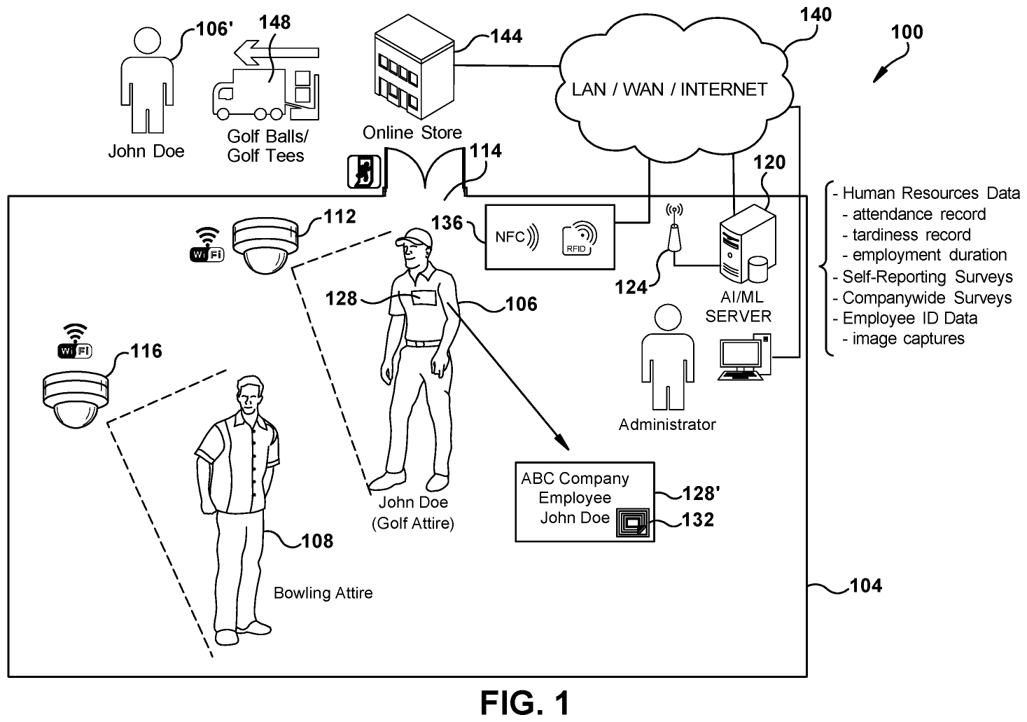

Referring now to the drawings, FIG. 1 illustrates an example embodiment of a system 100 for employee retention. In the illustrated example, company employees work at a business premises 104, including employees 106 and 108. One or more digital cameras are suitably connected to server 120, by any suitable wireless or wired data connection, including camera 112, disposed at entryway 114 and camera 116, disposed elsewhere in the business premises 104. In the illustrated example, cameras 112 and 116 are in wireless data communication via a Wi-Fi connection to hotspot 124. Employees, such as employee 106, designated with the name John Doe, are provided with an employee badge. Employee 106 is wearing ID badge 128, illustrated in exploded view 128′. ID badge 128 includes electronic identification, such as with an embedded radio frequency identification (RFID) or nearfield communication (NFC) chip/antenna 132, suitably communicating to a corresponding wireless receiver 136. Wireless receiver 136 is in data communication with network cloud 140, suitably comprised of a local area network (LAN), a wide area network (WAN), which may comprise the Internet, or any suitable combination thereof.

In a particular example, when employee 106 enters business premises 104 at entryway 114, the employee is wirelessly identified by his company ID badge 128 via wireless receiver 136. An image of the identified employee is captured by camera 112. Employee information and captured image data is communicated to server 120 via network cloud 140. As will be detailed further below, captured image data is subjected to analysis by application of artificial intelligence (AI) and machine learning (ML) by server 120, suitably including additional information. Such additional information may include human resources information, such as employee badge information, personal information, attendance record, tardiness record, employment duration, birthday, and the like. Additional information suitably implemented includes results from self-reporting or companywide services, employee ID data, additional image captures or a company holiday calendar. Fashion image data is also suitably implemented for analysis and recommendations, including information from Internet sites such as fashion site images or crowdsourcing data.

Once an employee image has been analyzed, recommendations to improve employee happiness are generated. A recommendation may include a personal or personalized employee gift corresponding to analysis of a captured employee image. In the illustrated example, employee 106 is determined to be in golfing attire and a recommended gift includes golf balls and golf tees. A corresponding order is suitably placed, automatedly or manually by an administrator, at online store 144. Online store 144 can then ship ordered goods for delivery to John Doe, illustrated at 106′.

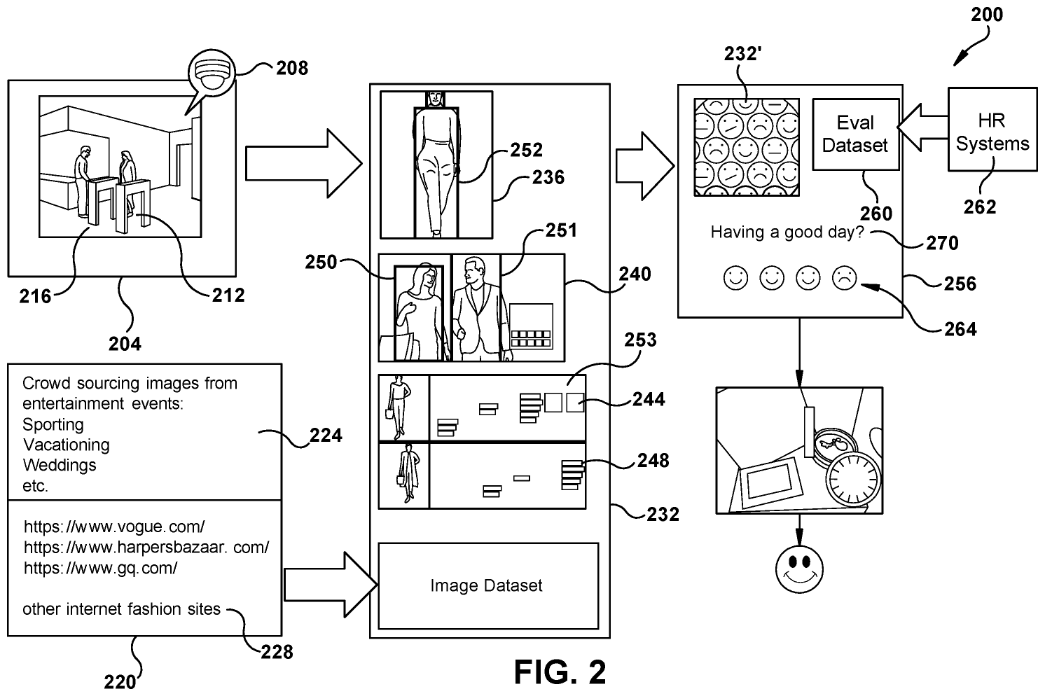

FIG. 2 illustrates an example embodiment of a system 200 for improving employee happiness. Image 204 is captured by digital camera 208, suitably disposed at a business entryway 212. When an employee wishes to enter, they place their badge on or near a wireless sensor on turnstile 216. The employee is identified and image 204 is captured. Additional information 220 is obtained, such as crowdsourcing images 224. Crowdsourcing images may include images from sporting events, vacations, weddings, or the like. Still further information may be obtained from websites, such as fashion websites 228. Captured images include an image of an employee's attire, including type of outfit, such as pants, dresses, shirt, ties, skirts, shoes, hats, and the like. Further metadata can be extracted from captured images, such as identification of a shirt as a dress shirt, short sleeve, long sleeve, sleeveless, tee shirt, collared shirt, tank top, or the like. Further metadata can be extracted from captured images, such as identification of shoes as tennis shoes, pumps, stilettos, dress shoes, sandals or boots. Such metadata allows for cataloging and association with a mood or personality of an associated employee.

Image 204, supplemented by additional information 220, forms image dataset 232. Image dataset 232 includes images such as images 236, 240, 244 and 248. Dataset images suitably include extracted patterns, such as pattern 252 from image 236 and patterns 250 and 251 from image 240. Image patterns are suitably associated with other image patterns, additional information or employee recommendations, such as illustrated by associative ordering 253 associated with image 244. Image dataset 232, illustrated at 232′, is analyzed at block 256, along with human resources information 262, to form an evaluation dataset 260, determine an employee happiness index 264, and a suggestion 270.

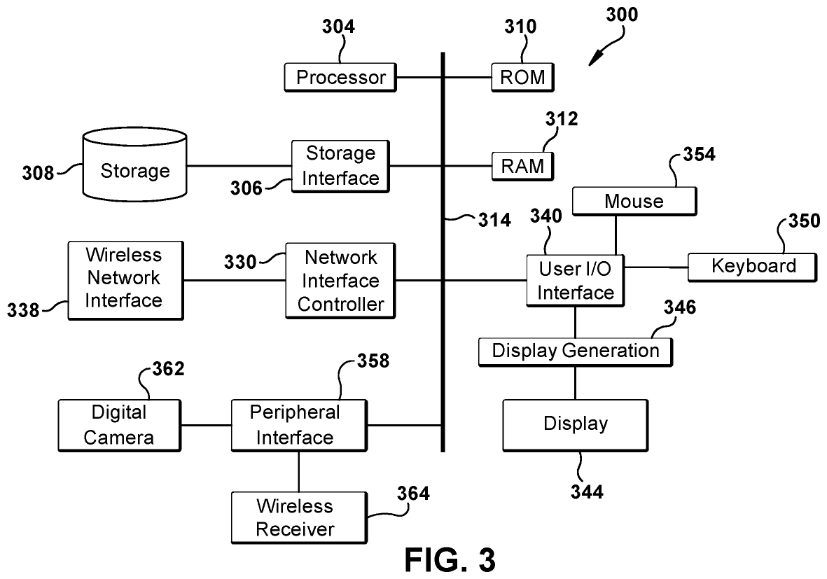

Turning now to FIG. 3, illustrated is an example embodiment of a digital data processing device 300 such as server 120 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. A network interface controller 330 suitably provides a gateway for data communication with other devices, such as via wireless network interface 338. A user input/output interface 340 suitably provides display generation 346 providing a user interface via display 344, suitably displaying images from display generation 346. Input/output interface 340 also provides an interface to keyboard 350 and mouse 354. Peripheral interface provides connectivity with devices such as digital camera 362 and wireless receiver 364. It will be understood that the computational platform to realize the system as detailed further below is suitably implemented on any or all of devices as described above.

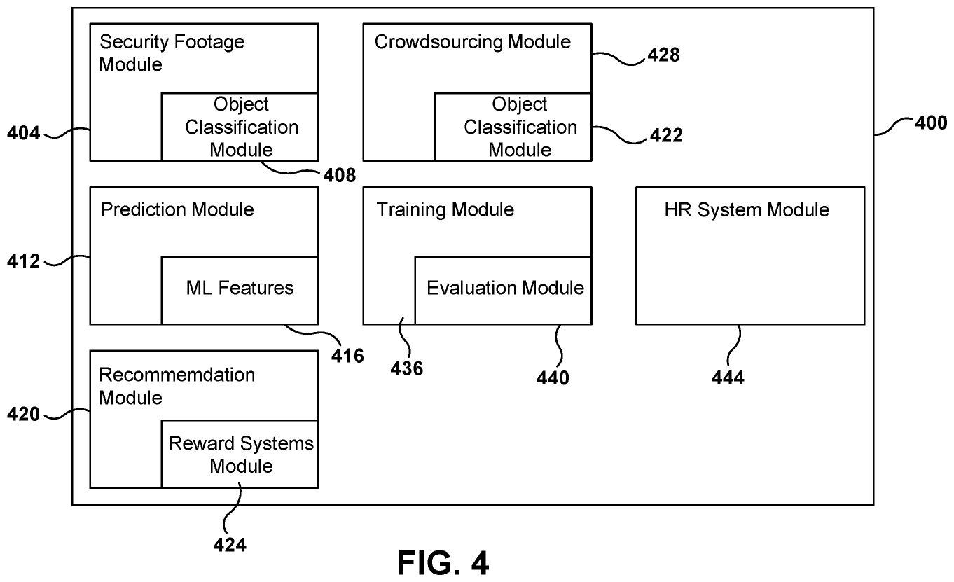

FIG. 4 illustrates an example embodiment of a software block diagram 400 suitably used in connection with systems described herein. Included is security footage module 404 that comprises object classification module 408. Prediction module 412 includes machine learning 416. Recommendation module 420 includes reward system module 424. Crowdsourcing module 428 includes object classification module 422. Training module 436 includes evaluation module 440. Calculations are made in concert with information from human resources system module 444.

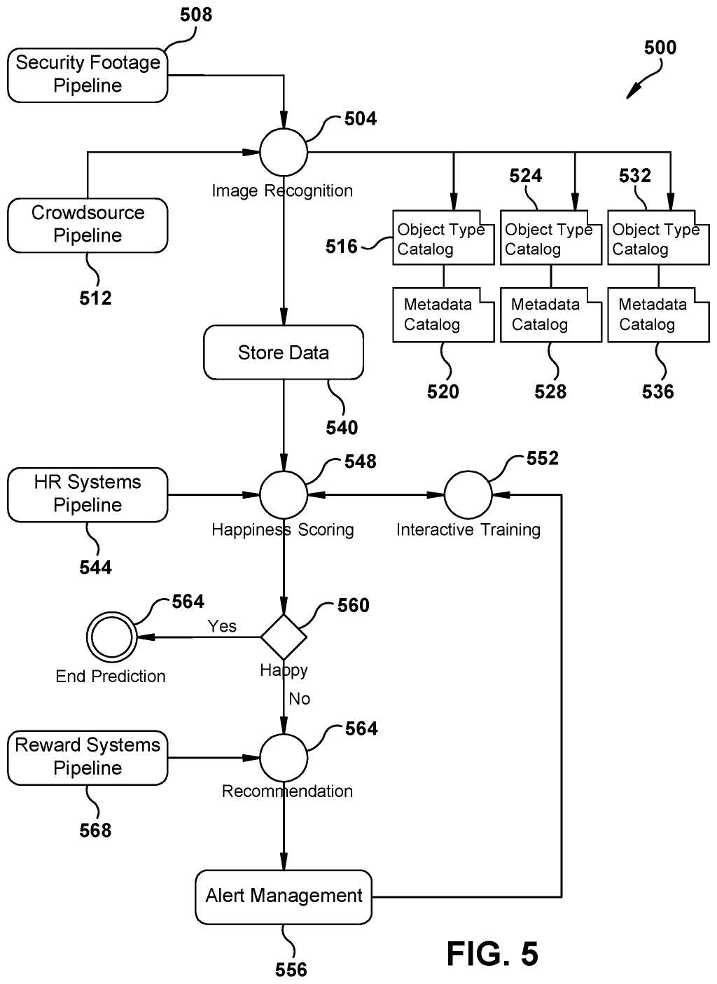

FIG. 5 illustrates flowchart 500 of an example embodiment of an employee retention system. Image recognition system 504 receives data from security footage pipeline 508 and crowdsource pipeline 512. Recognized images are subject to object type cataloging at block 516, which includes generation of an associated metadata catalog 520. Recognized images are also subjected to object type cataloging at block 524, which includes generation of an associated metadata catalog 528. Recognized images are also subject to object type cataloging at block 532, which includes generation of an associated metadata catalog 536.

Image recognition data is stored at block 540. Stored data, along with human resource pipeline data 544, provides happiness scoring at block 548. Such scoring directs interactive training at block 552, and generation and management of alerts at block 556.

Happiness scoring allows for a determination of an employee happiness level at block 560. If an employee is determined to be happy, a prediction iteration ends at block 564. If an employee is determined to be unhappy at block 560, such as having a happiness index below a preselected threshold level, a recommendation is generated at block 564, which may include engaging reward systems pipeline 568, before proceeding to alert generation and management at block 556.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor;
a digital camera configured to capture image data corresponding to human images from each of a plurality of identified employees;
a memory configured to store captured imaged data associatively with each identified employees;
the memory further configured to store a dataset corresponding to fashion images;
the processor configured to classify a clothing type for each identified employee in accordance with their associated, captured image; and
the processor further configured to generate a morale improvement recommendation for each identified employee in accordance with an assessment of their classified clothing type relative to the dataset; and
the processor further configured to output each of the morale improvement recommendations.

2. The system of claim 1 wherein the processor is further configured to:
assign a happiness index for each identified employee in accordance the assessment of their classified clothing type relative to the dataset; and
output the happiness index for each identified employee to an administrator.

3. The system of claim 2 wherein the processor is further configured to output morale improvement recommendations for each identified user for which their associated happiness index crosses a predetermined threshold level.

4. The system of claim 3 wherein the processor is further configured to:
recognize patterns in the captured image data; and
generate a modified dataset in accordance with application of machine learning to recognized patterns.

5. The system of claim 4 further comprising:
the memory storing data corresponding to a plurality of incentives wherein each incentive is associated with one or more classified clothing type; and
wherein the processor is further configured to output one or more incentives in accordance with each classified clothing type.

6. The system of claim 5 wherein the processor is further configured to initiate an online order for one or more items associated with output incentives.

7. The system of claim 1 further comprising a receiver configured to receive identification data from each employee when the image data is captured.

8. The system of claim 7 wherein the receiver is comprised of an RFID receiver or a NFC receiver in data communication with an employee ID.

9. A method comprising:
capturing, with a digital camera, image data corresponding to human images from each of a plurality of identified employees;
storing, in a memory, captured imaged data associatively with each identified employee;
storing, in the memory, a dataset corresponding to fashion images;
classifying, via a processor, a clothing type for each identified employee in accordance with their associated, captured image; and
generating, via the processor, a morale improvement recommendation for each identified employee in accordance with an assessment of their classified clothing type relative to the dataset; and
outputting each of the morale improvement recommendations.

10. The method of claim 9 further comprising:
assigning, via the processor, a happiness index for each identified employee in accordance the assessment of their classified clothing type relative to the dataset; and
outputting the happiness index for each identified employee to an administrator.

11. The method of claim 10 further comprising outputting morale improvement recommendations for each identified user for which their associated happiness index crosses a predetermined threshold level.

12. The method of claim 11 further comprising:
recognizing, via the processor, patterns in captured image data; and
generating, via the processor, a modified dataset in accordance with application of machine learning to recognized patterns.

13. The method of claim 12 further comprising:
storing, in the memory, data corresponding to a plurality of incentives wherein each incentive is associated with one or more classified clothing type; and
outputting one or more incentives in accordance with each classified clothing type.

14. The method of claim 13 further comprising initiating, via the processor, an online order for one or more items associated with output incentives.

15. The method of claim 9 further comprising receiving identification data from each employee when the image data is captured.

16. The method of claim 15 further comprising receiving the identification data via an RFID receiver or a NFC receiver in data communication with an employee ID.

17. A system comprising:
a wireless receiver positioned at an entry of a premises;
a digital camera positioned at the entry of the premises;
the wireless receiver configured to identify an employee entering the premises at the premises entry;
a processor configured to capture a digital image of an identified employee via the digital camera;
a memory configured to store images associated with a plurality of attire classifications;
the memory further configured to store a first recommendation associatively with each attire classification;
the processor further configured to apply pattern recognition a captured digital image;
the processor further configured to associate the captured digital image with one or more attire classifications in accordance with applied pattern recognition;
the processor further configured to generate a happiness index for the identified employee in accordance with an associated attire classification;
the processor further configured to store the happiness index in the memory;
the processor further configured to select a second recommendation corresponding to the associated attire classification when the happiness index crosses a preselected threshold level; and
the processor further configured to output an identity of the identified employee, the happiness index and a selected recommendation to an associated administrator.

18. The system of claim 17 wherein the processor is further configured to modify the attire classification in accordance with machine learning applied to the happiness index.

19. The system of claim 18 wherein the processor is further configured to generate the happiness index in accordance with a human resources data record of the identified employee.

20. The system of claim 19 wherein the processor is further configured to classify stored images in accordance with data received from fashion websites via an associated network interface.
